(19) United States
(12) Patent Application Publication
(10) Pub. No.: US 2014/0231700 A1
(43) Pub. Date: Aug. 21, 2014

(54) THERMOCONDUCTIVE RESIN COMPOSITION

(71) Applicant: Panasonic Corporation, Osaka (JP)

(72) Inventors: Yuki Kotani, Osaka (JP); Tomokazu Kusunoki, Osaka (JP); Hiroyoshi Yoden, Osaka (JP)

(21) Appl. No.: 14/347,412

(22) PCT Filed: Dec. 26, 2012
(86) PCT No.: PCT/JP2012/084273

§ 371 Date: Mar. 26, 2014

(30) Foreign Application Priority Data
Dec. 27, 2011 (JP) 2011-286477
Jul. 31, 2012 (JP) 2012-169918

(51) Int. Cl. C09K 5/14

(52) U.S. Cl. CPC C09K 5/14
USPC 252/74

(57) ABSTRACT

The present invention provides a thermally conductive resin composition which can realize high thermal conduction without increasing a content of a thermally conductive filler by including a specific thermally conductive inorganic filler, and also exhibits satisfactory moldability. Disclosed is a thermally conductive resin composition, including: a thermally conductive filler; and a binder resin, wherein the thermally conductive resin composition contains, as the thermally conductive filler, an irregularly shaped filler having projection/recess structures on its surface.

### BACKGROUND OF THE INVENTION

1. Field of the Invention

The present disclosure relates to a thermally conductive resin composition which is used in thermally conductive parts such as electronic parts, for example, radiators.

2. Description of the Related Art

Semiconductors of computers (CPUs), transistors, light emitting diodes (LEDs), and the like sometimes cause generation of heat during their use. This leads to deterioration of performance of electronic parts due to heat. Therefore, a radiator is attached to the electronic parts which cause the generation of heat.

Metals with high thermal conductivity have been used in such radiator. And a thermally conductive resin composition, which exhibits high degree of freedom in selection of shape and is also easy to achieve weight reduction and miniaturization, has recently come into use. It is necessary for such thermally conductive resin composition to contain a large amount of thermally conductive inorganic filler in a binder resin so as to improve thermal conductivity. However, it has been known that various drawbacks are caused by simply increasing a blending amount of the thermally conductive inorganic filler. For example, an increase in the blending amount causes an increase in viscosity of the resin composition before curing. And also it causes significant deterioration of moldability and workability, resulting in poor molding. There is a limitation on a filling amount of the filler, and thermal conductivity is often insufficient (Japanese Unexamined Patent Application Publications No. 63-10616 A, No. 4-342719 A, No. 4-300914 A, No. 4-211422 A, No. 4-345640 A).

The embodiments of the present invention have been made in light of the above circumstances. And these are directed to provide a thermally conductive resin composition which can realize high thermal conduction without increasing a content of a thermally conductive filler, and also exhibits satisfactory moldability and workability.

### SUMMARY OF THE INVENTION

The present inventors have intensively studied so as to achieve the above object. And they found that use of an irregularly shaped filler having an irregular projection/recess structure on a surface as the thermally conductive filler enables an increase in contact point between thermally conductive fillers and an increase in thermal conduction paths. This leads to high thermal conductivity regardless of a small filling amount of the thermally conductive filler. The present inventors have also found that a small filling amount of the thermally conductive filler leads to satisfactory moldability of a thermally conductive resin composition containing the thermally conductive filler. Thus, the embodiments of the present invention have been completed.

The present disclosure is directed to a thermally conductive resin composition, including: a thermally conductive filler; and a binder resin, wherein

the thermally conductive resin composition contains, as the thermally conductive filler, an irregularly shaped filler (an irregularly indented filler) having projection/recess structures on its surface.

In the thermally conductive resin composition according to the present disclosure, in an aspect, the irregularly shaped filler comprises a secondary particle assembled by bonding a plurality of the thermally conductive primary particles together.

In the thermally conductive resin composition according to the present disclosure, in another aspect, one particle composing the irregularly shaped filler includes a first particle and a second particle having a particle size being smaller than that of the first particle, and a plurality of the second particles are bonded to a surface of a core portion of the first particle to form the projection/recess structures on a surface of the core portion.

In the thermally conductive resin composition according to the present disclosure, the irregularly shaped filler preferably has a median diameter of 10 to 100 μm.

The thermally conductive resin composition according to the present disclosure may further include, as the thermally conductive filler, a small diameter filler having a median diameter being smaller than that of the irregularly shaped filler.

In the thermally conductive resin composition according to the present disclosure, the small diameter filler preferably has a median diameter of 1 to 10 μm.

In the thermally conductive resin composition according to the present disclosure, a volume ratio of the irregularly shaped filler to the small diameter filler is preferably from 4:6 to 7:3.

The thermally conductive resin composition according to the present disclosure preferably contains 35 to 80% by volume of the thermally conductive filler.

The present disclosure is also directed to a thermally conductive molding obtained by molding the above-mentioned thermally conductive resin composition, projections of other particles of the irregularly shaped filler entered into the recesses of particles of the irregularly shaped filler.

The present disclosure is also directed to a thermally conductive molding obtained by molding the above-mentioned thermally conductive resin composition containing the above-mentioned irregularly shaped filler and small diameter filler as the thermally conductive filler, wherein the small diameter filler enters into the recesses of particles of the irregularly shaped filler.

In the thermally conductive resin composition according to the embodiments of the present invention, since an irregularly shaped filler having an irregular projection/recess structure on a surface is used as a thermally conductive filler, the number of contact points between, thermally conductive fillers increase and thermal conduction paths increase, leading to high thermal conductivity regardless of a small filling amount of the thermally conductive filler. Small filling amount of the thermally conductive filler ensures fluidity of the thermally conductive resin composition to improve moldability, leading to satisfactory workability.

According to the embodiments of the present invention, it is possible to provide a thermally conductive resin composition which can realize high thermal conduction without increasing the content of the thermally conductive filler, and also exhibits satisfactory moldability and workability.

### BRIEF DESCRIPTION OF THE DRAWINGS

FIG. 1 is a SEM micrograph of a surface of an irregularly shaped filler contained in a thermally conductive resin composition according to an embodiment of the present invention.

FIG. 2 is a SEM micrograph of a cross section of an irregularly shaped filler contained in a thermally conductive resin composition according to the embodiment of the present invention.

FIG. 3 is a schematic view of a cross section of the irregularly shaped filler shown in FIG. 2.

FIG. 4A is a conceptual perspective view of an irregularly shaped filler.

FIG. 4B is a bottom view of the irregularly shaped filler.

FIG. 5 is a schematic view of a thermally conductive resin composition according to the embodiment of the present invention which contains an irregularly shaped filler and a spherical small diameter filler as thermally conductive fillers.

FIG. 6 is a schematic view of a conventional thermally conductive resin composition, which contains a spherical large diameter filler and a spherical small diameter filler as thermally conductive fillers.

FIG. 7 is a schematic view of a molding 12 made of a thermally conductive resin composition 1 which contains only an irregularly shaped filler 4 as the thermally conductive filler 2.

FIG. 8 is a schematic view of a molding 12 made of a thermally conductive resin composition 1 which contains an irregularly shaped filler 4 and a small diameter filler 5 as the thermally conductive fillers 2.

FIG. 9 is a schematic view showing a method for producing an irregularly shaped filler by bonding other thermally conductive filler particles to thermally conductive filler particles through a bonding means.

### DESCRIPTION OF THE EMBODIMENTS

Mode for carrying out the present invention will be described in detail below with reference to the accompanying drawings. The following embodiment illustrates a thermally conductive resin composition for specifying technical idea of the present invention. And they do not limit the present invention. The size, material, shape, and relative arrangement of the components illustrated in the present embodiment are not intended to limit the scope of the present invention only to these unless otherwise specified, but are merely illustrative. The size and positional relation of members illustrated by the respective drawings are sometimes exaggerated so as to clarify the description.

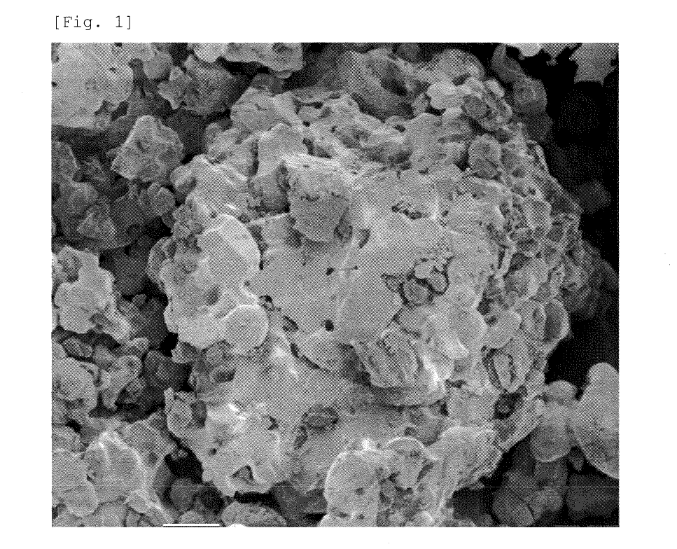

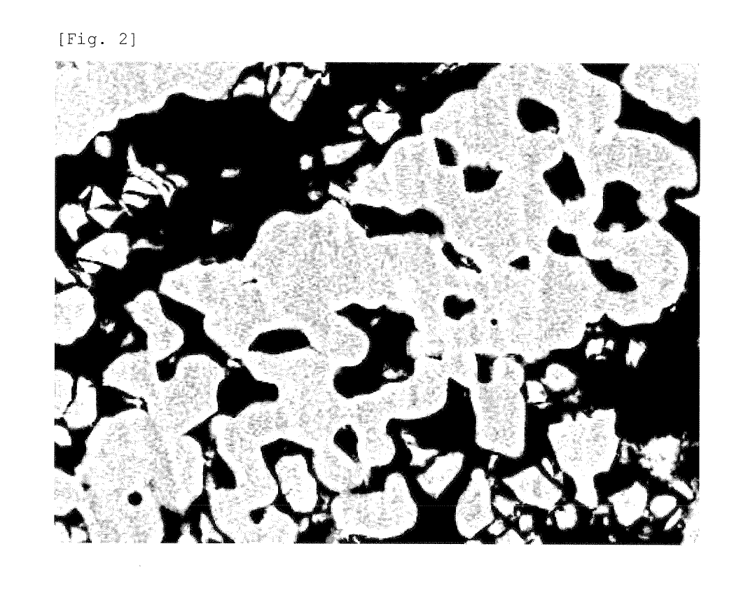

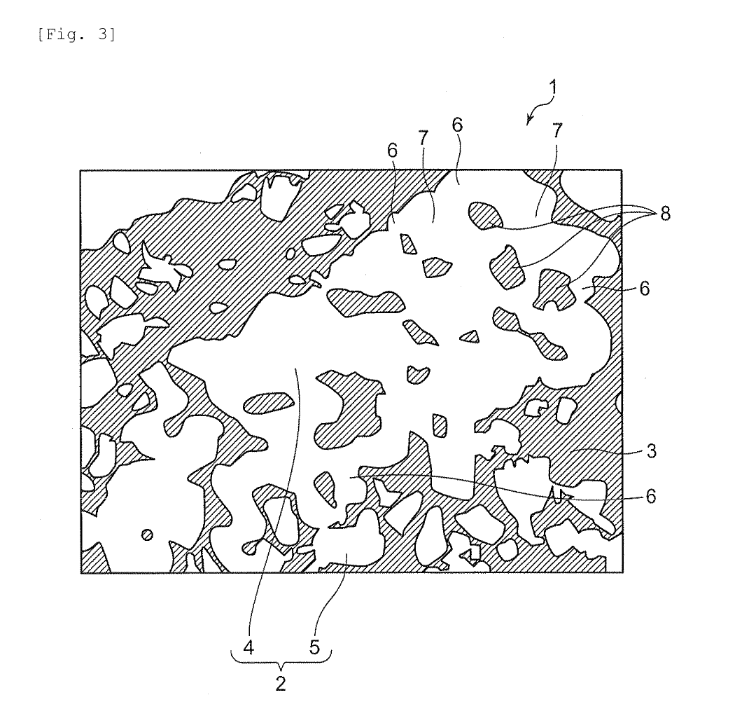

FIG. 1 is a surface image produced by a scanning electron microscope (hereinafter referred to as SEM) of the thermally conductive resin composition according to a first embodiment of the present invention. FIG. 2 is a cross-sectional image produced by SEM of a thermally conductive resin composition. FIG. 3 is a schematic view thereof. A description is herein made on the case where the thermally conductive filler particles 7 are bonded to each other by thermal welding to form a projection/recess structure on a surface of an irregularly shaped filler. But the present invention is not limited to thermal welding and thermally conductive filler particles may be bonded to each other by any method. Hereinafter, a description will be made on the case where the thermally conductive filler particles are bonded to each other by thermal welding to produce the irregularly shaped filler.

As shown in FIG. 3, a thermally conductive resin composition 1 according to a first embodiment of the present invention includes a thermally conductive filler 2 and a binder resin 3. And the thermally conductive resin composition 1 contains, as the thermally conductive filler 2, an irregularly shaped filler 4. The irregularly shaped filler 4 is composed of a secondary particle. The secondary particle is an assembly which is made by bonding a plurality of the thermally conductive primary particles together. And the assembly has an irregular projection/recess structure on a surface. The thermally conductive resin composition 1 according to the present invention may also contain a small diameter filler 5 as the thermally conductive filler 2.

In the present invention, the primary particle as used herein means a particle as a minimum unit composing the irregularly shaped filler 4 (corresponding to a thermally conductive filler particle). The secondary particle means an aggregate in which primary particles are aggregated (corresponding to an irregularly shaped filler 4). It is preferred that primary particle is firmly fixed by welding, bonding, or the like.

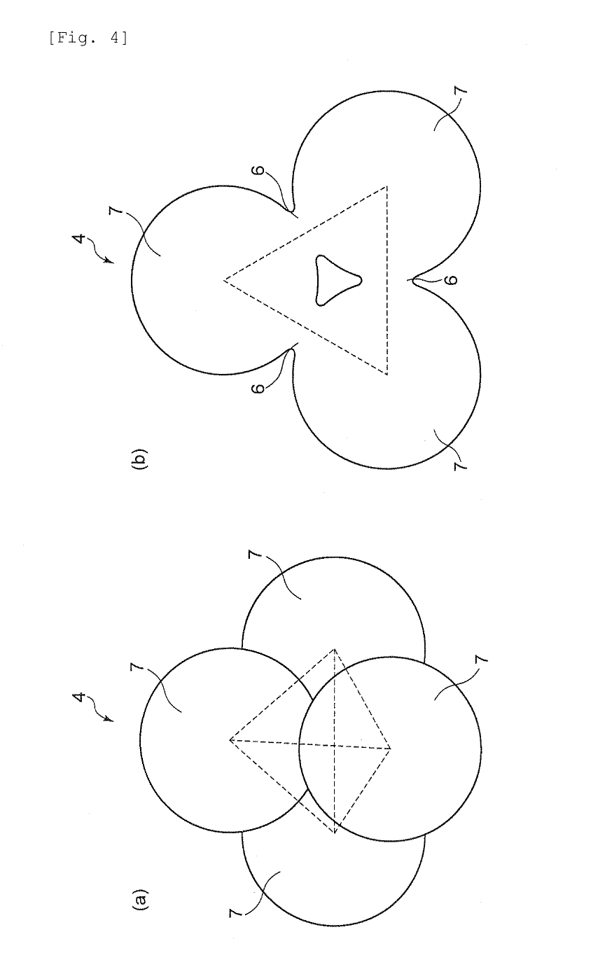

A description will be made in detail on a shape of the irregularly shaped filler 4 to be contained as the thermally conductive filler 2 of the thermally conductive resin composition according to a first embodiment of the present invention. As shown in FIG. 3, the irregularly shaped filler 4 has a configuration in which a plurality of the thermally conductive filler particles 7 as primary particles are partially welded to each other. And thus a plurality of the welded portions 6 are formed in a remote location. And a gap 8 is formed between the thermally conductive filler particle 7 and the thermally conductive filler particle 7. And also an irregular projection/recess structure is formed on a surface of the irregularly shaped filler 4. Describing conceptually about the case of being composed of four thermally conductive filler particles, for example, as shown in FIGS. 4A and 4B, these four thermally conductive filler particles 7 locate at each apex of an approximately tetrahedron. And each thermally conductive filler particle 7 is welded with each other thermally conductive filler particle 7. And thus, a neck-shaped welded portion 6 is formed in the vicinity of an intermediate portion of the apex of the approximately tetrahedron.

The irregularly shaped filler 4 to be formed by the above-mentioned welding is preferably at least one selected from the group consisting of MgO, Al₂O₃, and SiO₂. MgO, Al₂O₃, and SiO₂ per se are excellent in thermal conductivity. And they are produced by heating the thermally conductive filler particles 7, which are in contact with each other, at a temperature of a melting temperature thereof or lower. Specifically they are heated at a melting temperature of 800° C. to a melting temperature of 2,500° C., and more preferably a melting temperature of 1,000° C. to a melting temperature of 2,000° C. More specifically, the heating temperature is from about 1,800° C. to about 2,000° C. when using magnesium oxide as the thermally conductive filler particles 7. And the heating temperature is from about 1,000° C. to 1,500° C. when using aluminum oxide as the thermally conductive filler particles 7. The optimum heating temperature can be appropriately set from a melting temperature of the filler depending on kinds of the used filler. The irregularly shaped filler 4 having an irregular projection/recess structure on a surface can be produced by heating the thermally conductive filler particles 7 at a temperature within the above temperature range. Regarding the irregularly shaped filler 4 produced in the manner mentioned above, numerous contact points between the thermally conductive filler 2 are formed in the thermally conductive resin composition 1, and thus improving thermal conductivity.

As mentioned above, in case that the irregularly shaped filler 4 is formed by welding, the thermally conductive filler particles 7 are preferably composed of a single component from a viewpoint of ease of welding. If the thermally conductive filler particles 7 are weldable with each other, the thermally conductive filler particles 7 may be composed of two or more components.

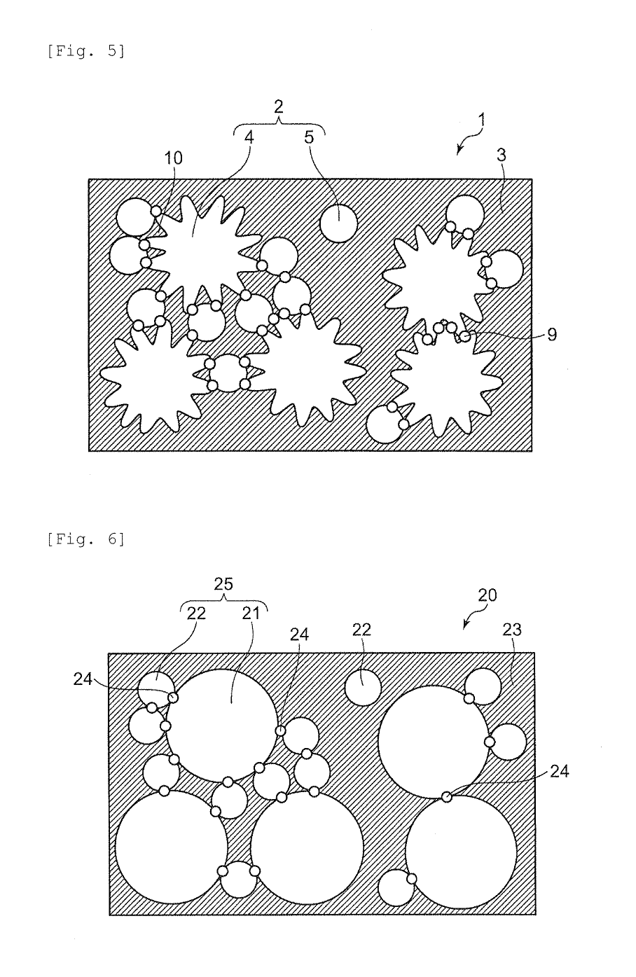

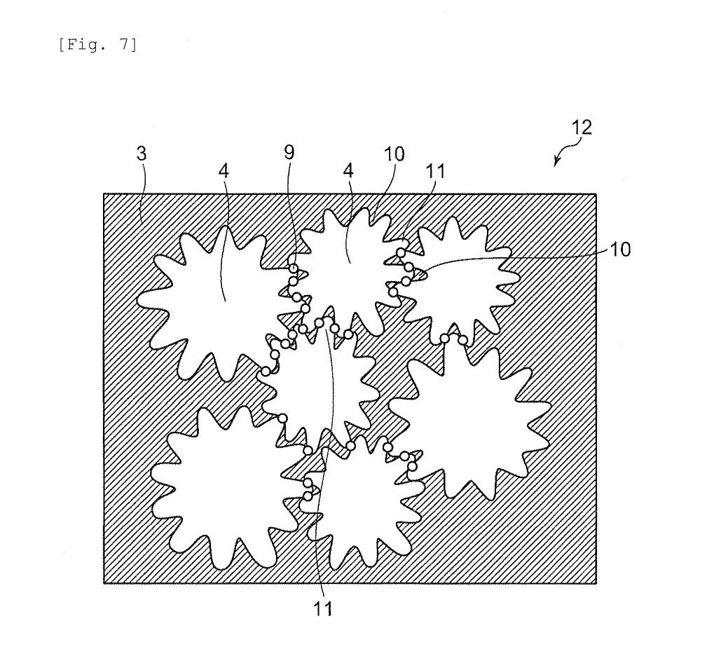

The irregularly shaped filler 4 contained in the thermally conductive resin composition according to the present embodiment is usually formed by welding four or more thermally conductive filler particles 7, as shown in FIG. 3. A plurality of the thermally conductive filler particles 7 are partially welded with each other. Thus, a plurality of the welded portions 6 are formed in a remote location. And a gap 8 is formed between the thermally conductive filler particle 7 and the thermally conductive filler particle 7. And also an irregular projection/recess structure is formed on a surface of the irregularly shaped filler 4. The irregularly shaped filler 4 has an irregular projection/recess structure on a surface. Thus, a surface area increases as compared with a spherical or crushed conventional filler. Therefore, numerous contact points between thermally conductive filler 2 are formed, and thus improving thermal conductivity. Furthermore, the number of contact points is increased by increasing the content of the thermally conductive filler 2 while maintaining moldability of the thermally conductive resin 1 by using the irregularly shaped filler 4 in combination with the small diameter filler 5 having a smaller particle size than that of the irregularly shaped filler 4, and thus enabling realization of higher thermal conduction. A schematic view (SEM image) of the thermally conductive resin composition 1 is shown in FIGS. 5 and 6. FIG. 6 is a schematic view (SEM image) of a conventional thermally conductive resin composition containing a large diameter filler and a small diameter filler. FIG. 5 is a schematic view (SEM image) of a thermally conductive resin composition according to an embodiment of the present invention, containing an irregularly shaped filler and a small diameter filler. As shown in FIG. 6, in the conventional thermally conductive resin composition 20, the large diameter filler 21 and the small diameter filler 22 have a spherical shape and a small surface area. Thus, the number of contact points 24 between thermally conductive fillers 25 is smaller than the irregularly shaped filler 4 having a projection/recess structure on a surface. Therefore, thermal conductivity is low regardless of a large filling amount of the thermally conductive filler. Herein, in the conventional thermally conductive resin composition 20, the number of contact points 24 between the fillers is decided by the content of the thermally conductive filler 25. On the other hand, in the thermally conductive resin composition 1 according to the embodiment of the present invention, a contact area of the irregularly shaped filler 4 is large as shown in FIG. 5. Thus, the number of contact points 9 increases as compared with the conventional thermally conductive resin composition 20 shown in FIG. 6. As a result, thermal conduction paths are efficiently formed. Thus, it becomes possible to realize high thermal conduction of the thermally conductive resin composition 1.

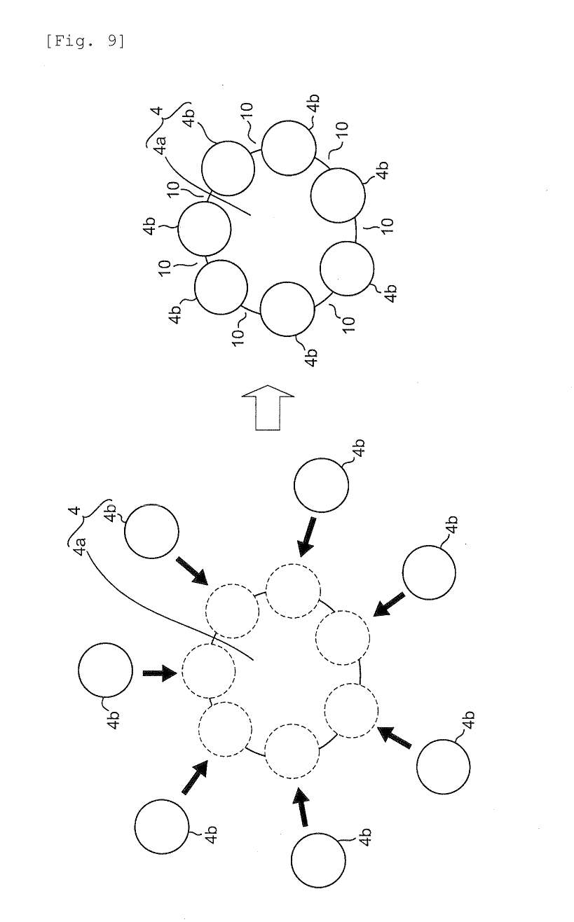

The method for producing an irregularly shaped filler is not limited to the above-mentioned method for welding a plurality of the thermally conductive filler particles 7. And it may be any method as long as other thermally conductive filler particle is bonded to the thermally conductive filler particles by some bonding means. As shown in FIG. 9, one particle composing the irregularly shaped filler includes a first particle 4a and a second particle 4b. The second particle 4b has a particle size which is smaller than that of the first particle 4a. And a plurality of the second particles 4b may be bonded to a surface of a core portion including the first particle 4a. Thus, a projection/recess structure is formed on a surface of the core portion. Using, as a bonding means, for example, an adhesive containing a sol-gel liquid as a bonding component, a plurality of the thermally conductive filler particles are bonded to a plurality of other thermally conductive filler particles. And thus it is made possible to produce the irregularly shaped filler having the projection/recess structure. In this case, it is also possible to bond different kinds of thermally conductive fillers. In addition, it is also possible to control the size of the projection/recess structure by appropriately selecting the particle size of the thermally conductive filler, kinds of the sol-gel liquid, heating temperature, curing time of the adhesive, and the like. It is also positive to use, as specific examples of the bonding means, an organic compound having a reactive functional group, in addition to the adhesive containing a sol-gel liquid as a bonding component. Use of such organic compound as the bonding means enables formation of a firm projection/recess structure on a surface of the irregularly shaped filler.

The method for bonding other thermally conductive filler particle to the thermally conductive filler particles by the bonding means enables saving of production costs. This is because the heating temperature is low as compared with the method for bonding other thermally conductive filler particle to thermally conductive filler particles through bonding.

The method for producing an irregularly shaped filler 4 is not limited to the above-mentioned welding. And any means can be used as long as it is possible to bond other thermally conductive filler particle to the thermally conductive filler particles. For example, as shown in the above-mentioned drawings, the irregularly shaped filler may be composed of a thermally conductive filler 4a and a thermally conductive filler 4b. If a median diameter of the thermally conductive filler 4a is larger than that of the thermally conductive filler 4b, an ideal projection/recess structure is formed and thermal conduction paths are efficiently formed. Therefore, in case that the irregularly shaped filler is produced by bonding, the median diameter of the thermally conductive filler 4a is preferably 10 μm or more, and more preferably 50 to 90 μm, from a viewpoint of improving thermal conductivity. The median diameter of the thermally conductive filler 4b is preferably from 1 to 30 μm, and more preferably from 1 to 10 μm. In this irregularly shaped filler 4, a pore diameter of recesses 10 is preferably from 1 to 30 μm, and more preferably from 1 to 10 μm. As used herein, the median diameter means a particle diameter (d50) in which an integrated (cumulative) weight percentage becomes 50%. And the median diameter can be measured by using Laser Diffraction Particle Size Distribution Analyzer “SALD2000” (manufactured by Shimadzu Corporation).

The thermally conductive filler 4a, 4b is not particularly limited to and is preferably MgO, Al₂O₃, SiO₂, boron nitride, aluminum hydroxide, and aluminum nitride. And also the thermally conductive filler 4a, 4b includes magnesium carbonate, magnesium hydroxide, calcium carbonate, clay, talc, mica, titanium oxide, zinc oxide, and the like. In particular, an organic filler may also be used.

An example of a method for producing such irregularly shaped filler will be described. First, the thermally conductive filler 4b is mixed with a metal alkoxide, a solvent, water used for hydrolysis, and a catalyst to prepare a slurry. The slurry is sprayed over the thermally conductive filler 4b, and subjected to a heat-burn-treatment, followed by an optional crushing and a classification. Thus, a plurality of the thermally conductive fillers 4b are bonded to the thermally conductive filler 4a through metal oxide. And thus it is made possible to produce the irregularly shaped filler 4 having a projection/recess structure.

The metal oxide can be formed by hydrolysis and condensation of a metal alkoxide, or a hydrolyzate thereof, or a condensate of them. And the metal oxide includes, for example, Si-based alkoxide such as tetramethoxysilane and tetraethoxysilane. It is also possible to use metal alkoxides of Al, Mg, Ti, Zr, Ge, Nb, Ta, Y, and the like.

Specifically, the metal oxide is formed by hydrolysis and condensation of a metal alkoxide represented by the following chemical formula (1) or chemical formula (2), or a hydrolyzate thereof, or a condensate of them.

(Chemical Formula 1)

M¹(OR¹)ₘ (1)

(Chemical Formula 2)

M²(OR²)ₙ₋ₓ(R³)ₓ (2)

In the above chemical formulas (1) and (2), each of M¹ and M² is metal selected from Si, Ti, Al, Zr, Ge, Nb, Ta, and Y. R¹ and R² are alkyl groups or hydrogens, and all substituents may be the same, or different substituents may coexist. R³ is an alkyl group, and all substituents may be the same, or different substituents may coexist. m is an integer which is the same as a valence of M¹, n is an integer which is the same as a valence of M². x is an integer of 1 or more, and n>x.

The compound represented by the chemical formula (1) may be a metal alkoxide in which all R¹(s) are alkyl groups such as a methyl group, an ethyl group, a propyl group, and a butyl group. And R¹(s) may be partially alkyl groups and balance may be hydrogens. In case that all R¹(s) are hydrogens, it is possible to use a hydrolyzate of the metal alkoxide. There is no particular limitation on the alkyl group represented by R¹ of the chemical formula (1), and the number of carbon atoms is preferably within a range from 1 to 5.

Specific examples of the metal alkoxide represented by the chemical formula (1) include substituted or unsubstituted alkoxysilanes, such as tetramethoxysilane, tetraethoxysilane, tetra-n-propoxysilane, tetraisopropoxysilane, tetra-n-butoxysilane, and tetrakis(2-methoxyethoxy)silane; substituted or unsubstituted aluminum alkoxides, such as aluminum triethoxide, aluminum tri-n-propoxide, aluminum triisopropoxide, aluminum tri-n-butoxide, aluminum triisobutoxide, aluminum tri-sec-butoxide, aluminum tri-tert-butoxide, aluminum tris(hexyloxide), aluminum tris(2-ethylhexyloxide), aluminum tris(2-methoxyethoxide), aluminum tris(2-ethoxyethoxide), and aluminum tris(2-butoxyethoxide); titanium alkoxides such as titanium tetraethoxide, titanium tetra-n-propoxide, titanium tetraisopropoxide, titanium tetra-n-butoxide, titanium tetra-sec-butoxide, and titanium tetrakis(2-ethylhexyloxide); zirconium alkoxides such as zirconium tetraethoxide, zirconium tetra-n-propoxide, zirconium tetraisopropoxide, zirconium tetra-n-butoxide, zirconium tetra-sec-butoxide, and zirconium tetrakis(2-ethylhexyloxide); germanium alkoxides such as germanium tetraethoxide, germanium tetra-n-propoxide, germanium tetraisopropoxide, germanium tetra-n-butoxide, germanium tetra-sec-butoxide, and germanium tetrakis(2-ethylhexyloxide); or yttrium alkoxides such as yttrium hexaethoxide, yttrium hexaethoxide-n-propoxide, yttrium hexaethoxide isopropoxide, yttrium hexaethoxide-n-butoxide, yttrium hexaethoxide-sec-butoxide, and yttrium hexaethoxidekis(2-ethylhexyl oxide). It is also possible to use a partially hydrolyzed condensate which is an oligomer of these metal alkoxides, or a mixture with a metal alkoxide which is a monomer.

The compound of the chemical formula (2) may be a metal alkoxide in which all R²(s) are alkyl groups such as a methyl group, an ethyl group, a propyl group, and a butyl group. And R²(s) may be partially alkyl groups and balance may be hydrogens. The compound may also be a hydrolyzate of a metal alkoxide in which all R²(s) are hydrogens. Furthermore, at least one alkyl group R³ is bonded to M², and this alkyl group R³ may be linear or branched. And examples thereof include ethyl, propyl, butyl, pentyl, hexyl, heptyl, and octyl. Examples of the substituted alkyl group include alkoxy-substituted alkyl groups such as 2-methoxyethyl, 2-ethoxyethyl, and 2-butoxyethyl. The number of carbon atoms of the alkyl group represented by R² of the chemical formula (2) is preferably within a range from 1 to 5, and the number of carbon atoms of the alkyl group represented by R³ is preferably within a range from 1 to 10.

Specific examples of the alkyl-substituted metal alkoxide of the chemical formula (2) include methoxysilanes such as methyltrimethoxysilane, dimethyldimethoxysilane, methyldimethoxysilane, trimethylmethoxysilane, ethyltrimethoxysilane, n-propyltrimethoxysilane, n-butyltrimethoxysilane, n-pentyltrimethoxysilane, n-hexyltrimethoxysilane, cyclohexyltrimethoxysilane, phenyltrimethoxysilane, vinyltrimethoxysilane, and methylvinyldimethoxysilane; ethoxysilanes such as methyltriethoxysilane, dimethyldiethoxysilane, methyldiethoxysilane, trimethylethoxysilane, vinyltriethoxysilane, and methylvinyldiethoxysilane; propoxysilanes such as methyltri-n-propoxysilane and methyltriisopropoxysilane; or substituted alkoxysilanes such as methyltris(2-methoxyethoxy)silane and vinyltris(2-methoxyethoxy)silane. It is also possible to use a partially hydrolyzed condensate of these alkoxides alone or a combination thereof. It is also possible to use metal alkoxides in which a metal species is aluminum, titanium, zirconium, germanium, or yttrium.

A metal oxide matrix may be formed using any one of the compound of the chemical formula (1) and the compound of the chemical formula (2). A metal oxide may be formed using the compound of the chemical formula (1) and the compound of the chemical formula (2) in combination.

Commonly used catalysts are used as a hydrolysis catalyst of the metal alkoxide. Examples thereof include inorganic acids such as hydrochloric acid, nitric acid, sulfuric acid, and phosphoric acid; organic acids such as organophosphoric acid, formic acid, acetic acid, acetic anhydride, chloroacetic acid, propionic acid, butyric acid, valeric acid, citric acid, gluconic acid, succinic acid, tartaric acid, lactic acid, fumaric acid, malic acid, itaconic acid, oxalic acid, mucic acid, uric acid, barbituric acid, and p-toluenesulfonic acid; an acidic cation exchange resin, a protonated layer silicate, and the like.

Use of this method enables bonding of two or more different kinds of the thermally conductive fillers. And it is possible to control a projection/recess structure by appropriately selecting the particle size of the thermally conductive filler, kinds of a sol-gel liquid, heating temperature, heating time, and the like.

In the crushing step, the bulky fired product obtained by burning is crushed into particles. Various techniques can be used in crushing of the fired product. Examples thereof include crushing by a mortar, crushing by ball mill, crushing using a V-shape rotating mixer, crushing using a cross rotary mixer, crushing by a jet mill, crushing by a crusher, a motor grinder, a vibration cup mill, a disk mill, a rotor spin mill, a cutting mill, or a hammer mill, and the like. It is possible to use, as the crushing method, a dry crushing method or a wet crushing method. In the dry crushing method, the fired product is crushed without using a solvent. In the wet crushing method, the fired product is put in a solvent such as water or an organic solvent, and then crushed in the solvent. Ethanol, methanol, and the like can be used as the organic solvent.

In the classification step, the thermally conductive filler obtained by crushing is converted into a particle assembly with predetermined particle size distribution. Various techniques can be used in classification, and examples thereof include classification by a sieve, classification using a sedimentation phenomenon of the thermally conductive filler in a solvent such as water or an alcohol, and the like. It is also possible to use, as the classification method, a dry classification method using no solvent, or a wet classification method in which the crushed product is put in a solvent such as water or an organic solvent, and then classified together with the solvent. The plurality of classification techniques are sometimes used for the purpose of obtaining sharp particle size distribution.

The irregularly shaped filler of the embodiment of the present invention have only to include a projection/recess structure on a surface. It may also be composed of the thermally conductive primary particles with a projection/recess structure. In the formation of the projection/recess structure on the surface, it is possible to form a projection/recess structure by etching the surface of the thermally conductive filler using an acid-based solution (for example, an aqueous solution of nitric acid, an aqueous solution of hydrofluoric acid, etc.). And it is possible to control a size of the projection/recess structure by appropriately setting kinds, concentration, temperature, etching time, and the like of the acidic solution. That is, a surface of one particle composing the irregularly shaped filler may be etched to form a projection/recess structure on the surface of the particle. The method for forming a projection/recess structure on a surface of the thermally conductive filler is not limited to a wet etching method using the above-mentioned acid-based solution. And the method for forming a projection/recess structure on its surface may be, for example, a dry etching method such as plasma etching (plasma gas etching). In the case of forming a projection/recess structure on a surface of a thermally conductive filler by plasma etching, for example, sputtering may be performed by collision of Ar ions against a surface of the thermally conductive filler in a state where the thermally conductive filler is allowed to float (namely, a surface of the thermally conductive filler may be physically etched). Examples of the substance to be collided against the surface of the thermally conductive filler include Ar ions, and the like. Ar ions are preferable since a proper projection/recess structure can be formed on the surface of the irregularly shaped filler. It is also possible to perform reactive gas etching using a fluorine-based gas (SF₆, CF₄, CHF₃, C₂F₆).

Examples of the etching method include a method in which an etching agent and a thermally conductive filler are usually dissolved and dispersed in a common solvent, and then a surface of the thermally conductive filler surface is partially removed. If fine particles are adhered in advance to a surface of a thermally conductive filler (namely, subjected to a masking treatment), followed by the etching treatment, etching slowly proceeds at the position where the masking treatment was performed. This leads to a difference in etching rate between the position where the masking treatment was not performed and the position where the masking treatment was performed. And thus formation of a projection/recess structure is enabled. Fine particles to be adhered in advance to the surface of the thermally conductive filler may be any one as long as the masking treatment can be performed. And specific examples thereof include fine particles of Al, Au, SiO₂, and the like. The fine particles of such materials enable satisfactory masking treatment to form a satisfactory projection/recess structure.

It is also possible to obtain an irregularly shaped filler having a projection/recess structure on a surface by burning an organic metal compound and controlling a crystal growth orientation. Projections may grow from a plurality of the positions of a surface of one particle composing the irregularly shaped filler. And thus a projection/recess structure is formed on the surface of the particle.

In the thermally conductive resin composition 1 according to a first embodiment of the present invention, the irregularly shaped filler 4 preferably has a median diameter of 10 to 100 μm. When the median diameter of the irregularly shaped filler 4 is from 10 to 100 μm, a thermally conductive resin composition can be obtained without causing a drawback in handling and moldability. Namely, the median diameter of 10 μm or more enables suppression of a viscosity of a resin from excessively increasing. The median diameter of 100 μm or less enables suppression of molding appearance from causing deterioration. More preferably, the median diameter of the irregularly shaped filler 4 is from 50 to 90 μm.

As shown in FIG. 5, the thermally conductive resin composition 1 according to a first embodiment of the present invention may contain, as the thermally conductive filler 2, a small diameter filler 5 having a smaller median diameter than that of the irregularly shaped filler 4, in addition to the irregularly shaped filler 4. Inclusion of the irregularly shaped filler 4 and the small diameter filler 5 as the thermally conductive filler 2 enables the small diameter filler 5 to enter into a recesses 10 of the surface of the irregularly shaped filler 4. And thus the number of contact points 9 between the irregularly shaped filler 4 and the small diameter filler 5 are increased. This leads to an increase in thermal conduction paths. Thus, thermal conductivity of thermally conductive resin composition 1 increases regardless of a small filling amount of the thermally conductive filler 2. Small filling amount of the thermally conductive filler 2 ensures fluidity of the thermally conductive resin composition 1 to improve moldability, leading to satisfactory workability.

In the thermally conductive resin composition 1 according to a first embodiment of the present invention, the small diameter filler 5 preferably has a median diameter of 1 to 10 μm. The small diameter filler 5 having a median diameter of 1 to 10 μm enables the small diameter filler 5 to enter into the space between the irregularly shaped fillers 4. This leads to an increase in contact area. An increase in viscosity of a resin is suppressed and it becomes easy to highly filling with a filler. And thus an improvement in thermal conductivity is enabled. More preferably, the median diameter of the small diameter filler 5 is from 3 to 8 μm.

In the thermally conductive resin composition 1 according to a first embodiment of the present invention, a volume ratio of the irregularly shaped filler 4 to the small diameter filler 5 is preferably from 4:6 to 7:3. If the volume ratio of the irregularly shaped filler 4 to the small diameter filler 5 is from 4:6 to 7:3, the small diameter filler 5 enters into the space between the irregularly shaped fillers 4. Therefore a close-packed structure is formed, and thus an increase in viscosity of a resin is suppressed. This leads to satisfactory moldability. It becomes easy to highly filling with a filler, and thus enabling an improvement in the thermal conductivity. More preferably, the content ratio of the irregularly shaped filler 4 to the small diameter filler 5 is from 4:6 to 6:4, and particularly preferably from 5:5 to 6:4.

The thermally conductive resin composition 1 according to a first embodiment of the present invention preferably contains 35 to 80% by volume of a thermally conductive filler 2. In case that the thermally conductive resin composition contains, as the thermally conductive filler 2, only an irregularly shaped filler 4, the irregularly shaped filler 4 is contained in the amount of 35 to 80% by volume based on the thermally conductive resin composition 1. In case that the thermally conductive resin composition contains, as the thermally conductive filler 2, a small diameter filler 5 in addition to the irregularly shaped filler 4, the irregularly shaped filler 4 and the small diameter filler 5 are contained in the amount of 35 to 80% by volume based on the thermally conductive resin composition 1. As mentioned above, inclusion of 35 to 80% by volume of the thermally conductive filler 2 enables formation of contact points between fillers with efficiency. And an improvement in thermal conductivity can be expected. When the content of the filler is 35% by volume or more, the effect of thermal conductivity due to an increase in the number of contact points between fillers can be sufficiently expected. On the other hand, when the content of the filler is more than 80% by volume, the viscosity of the resin during molding may become excessively high. When the content of the filler is 80% by volume or less, it is possible to suppress the viscosity of the resin during molding from becoming excessively high.

In the thermally conductive resin composition 1 according to a first embodiment of the present invention, a pore diameter of recesses 10 is preferably from 1 μm to 30 μm. More preferably, the pore diameter of recesses 10 is from 1 μm to 10 μm. When the pore diameter is within the above range, projections 11 of other particles of the irregularly shaped filler 4 enter into recesses 10 of the irregularly shaped filler 4. Alternatively, a small diameter filler 5 enters into recesses 10 of the irregularly shaped filler 4. This leads to an increase in the number of contact points between the fillers. Thermal conduction paths increases, and thus enabling further improvement in the thermal conductivity.

The material composing the small diameter filler 5 is not particularly limited. And the material composing the small diameter filler 5 includes, in addition to MgO, Al₂O₃, and SiO₂, boron nitride, aluminum hydroxide, magnesium carbonate, magnesium hydroxide, aluminum nitride, calcium carbonate, clay, talc, mica, titanium oxide, zinc oxide, and the like. Organic filler may also be used.

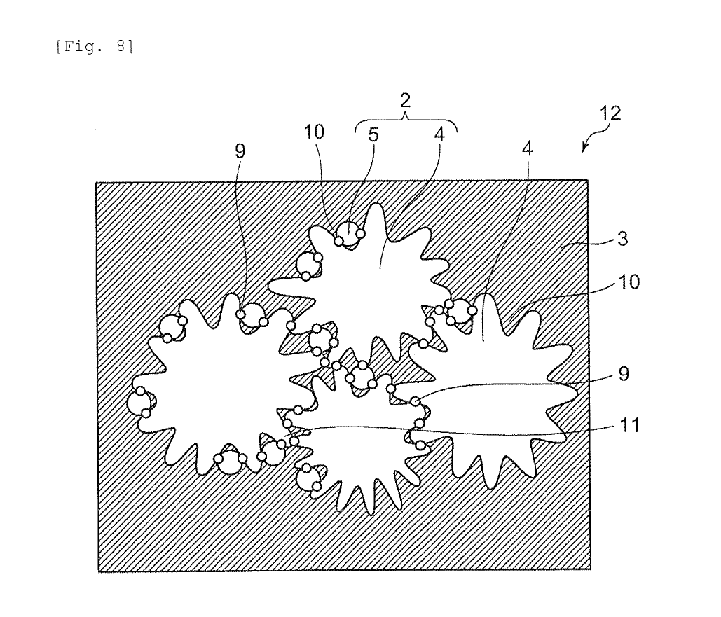

FIG. 7 is a schematic view of a molding 12 made of a thermally conductive resin composition 1 containing, as a thermally conductive filler 2, only an irregularly shaped filler 4. As shown in FIG. 7, in the molding 12, projections 11 of other particles of the irregularly shaped filler 4 enter recesses 10 of one particle of the irregularly shaped filler 4. As mentioned above, when projections 11 of other particles of the irregularly shaped filler 4 enter into recesses 10 of one particle of the irregularly shaped filler 4, the number of contact points between irregularly shaped filler 4 further increase. And thus a contact area also increases. Therefore, thermal conductivity of the molding 12 is improved.

FIG. 8 is a schematic view of a molding 12 made of a thermally conductive resin composition 1 which contains, as a thermally conductive filler 2, an irregularly shaped filler 4 and a small diameter filler 5. As shown in FIG. 8, in the molding 12, projections 11 of other particles of the irregularly shaped filler 4 enter into recesses 10 of one particle of the irregularly shaped filler 4. And also a small diameter filler 5 enters into vacant recesses 10 of the irregularly shaped filler. As mentioned above, when the small diameter filler 5 is contained as the thermally conductive filler 2, in addition to the irregularly shaped filler 4, the number of contact points 9 between the thermally conductive fillers 2 further increases. And thus a contact area also increases. Therefore, thermal conductivity of the molding 12 is improved.

### [Surface Treatment]

The thermally conductive filler 2 may be subjected to a surface treatment such as a coupling treatment so as to improve compatibility with a binder resin 3. Alternatively, dispersibility in a thermally conductive resin composition 1 may be improved by adding a dispersing agent.

In the surface treatment, organic surface treatment agents such as fatty acid, fatty acid ester, higher alcohol, and hydrogenated oil; or inorganic surface treatment agents such as silicone oil, silane coupling agent, alkoxysilane compound, and silylating agent are used. Use of these surface treatment agents may lead to an improvement in water resistance and an improvement in dispersibility in a binder resin 3. Examples of the treatment method include, but are not particularly limited to, (1) a dry method, (2) a wet method, (3) an integral blend method, and the like.

### (1) Dry Method

The dry method is a method in which a surface treatment is performed by adding dropwise a chemical while stirring a filler by mechanical stirring using a Henschel mixer, a Nautamixer, or a vibrating mill. Examples of the form of the chemical include a solution prepared by diluting silane with an alcohol solvent, a solution prepared by diluting silane with an alcohol solvent and further adding water, a solution prepared by diluting silane with an alcohol solvent and further water and an acid, and the like. The method for preparing a chemical is disclosed in a catalog of a manufacturing company of a silane coupling agent. The method for preparing a chemical is decided depending on a hydrolysis rate of silane, or kinds of a thermally conductive inorganic powder.

### (2) Wet Method

The wet method is a method in which a surface treatment is performed by directly immersing a filler in a chemical. Examples of the form of the chemical include a solution prepared by diluting an inorganic surface treatment agent with an alcohol solvent, a solution prepared by diluting inorganic surface treatment agent with an alcohol solvent and further adding water, a solution prepared by diluting inorganic surface treatment agent with an alcohol solvent and further water and an acid, and the like. The method for preparing a chemical is decided depending on a hydrolysis rate of an inorganic surface treatment agent, or kinds of a thermally conductive inorganic powder.

### (3) Integral Blend Method

The integral blend method is a method in which, when a resin is mixed with a filler, an inorganic surface treatment agent is directly added in a mixer in the form of an undiluted solution or a solution diluted with an alcohol, followed by stirring. The method for preparing a chemical is the same as those of the dry method and the wet method. In case that the surface treatment is performed by the integral blend method, the amount of silane is generally increased as compared with the above-mentioned dry method and wet method.

In the dry method and the wet method, a chemical is appropriately dried, as needed. In case that a chemical using an alcohol is added, the alcohol is vaporized. If the alcohol finally remains in the blend, the alcohol generates from the product in the form of a gas and exerts an adverse influence on the polymer component. Therefore, the drying temperature is preferably controlled to a boiling point of a solvent or higher. In order to quickly remove the inorganic surface treatment agent which did not react with the thermally conductive inorganic powder, heating is preferably performed to reach high temperature (for example, 100° C. to 150° C.) using a device. Taking heat resistance of the inorganic surface treatment agent into consideration, it is preferred to maintain at a temperature lower than the decomposition point of the inorganic surface treatment agent. The treatment temperature is preferably from about 80 to 150° C. And the treatment time is preferably from 0.5 to 4 hours. The drying temperature and the drying time are appropriately selected depending on the treated amount. Whereby, it also becomes possible to remove the solvent or the unreacted inorganic surface treatment agent.

The amount of the inorganic surface treatment agent, which is used to treat a surface of a thermally conductive filler 2, can be calculated by the following equation.

The amount of inorganic surface treatment agent (g)=[the amount of the thermally conductive inorganic powder (g)]×[the specific surface area (m²/g) of the thermally conductive inorganic powder]/[the minimum coating area (m²/g) of the inorganic surface treatment agent]

It is possible to determine “the minimum coating area of the inorganic surface treatment agent” by the following equation.

The minimum coating area (m²/g) of inorganic surface treatment agent=(6.02×10²³)×(13×10²⁰)/[the molecular weight of inorganic surface treatment agent]

where
6.02×10²³: Avogadro's constant
13×10⁻²⁰: area (0.13 nm²) covered with one molecule of inorganic surface treatment agent

The used amount of an inorganic surface treatment agent is preferably 0.5 times or more and less than 1.0 times the amount of the inorganic surface treatment agent calculated by this equation. If the upper limit is less than 1.0 times, it is possible to decrease the amount of the inorganic surface treatment agent, which actually exists on a surface of a thermally conductive inorganic powder, taking the amount of the unreacted filler into consideration. The reason why the lower limit was set at 0.5 time the amount calculated by the above calculation equation is that sufficient effect is exerted on an improvement in filling of a filler into a resin even if the amount is 0.5 time-amount.

### [Binder Resin]

There is no particular limitation on a binder resin 3 used in the embodiment of the present invention. Both a thermosetting resin and a thermoplastic resin can be used. From the viewpoint of capable of filling the thermally conductive filler 2 in higher density and exerting high effect of improving the thermal conductivity, the thermosetting resin is preferable.

Known thermosetting resins can be used. In view of particularly excellent moldability and mechanical strength, an unsaturated polyester resin, an epoxy-based acrylate resin, an epoxy resin, and the like can be used.

There is no particular limitation of kinds of the unsaturated polyester resin. The unsaturated polyester resin is composed, for example, of an unsaturated polybasic acid such as an unsaturated dicarboxylic acid (a saturated polybasic acid is optionally added), a polyhydric alcohol, and a crosslinking agent such as styrene. An acid anhydride is also included in the unsaturated polybasic acid or saturated polybasic acid.

Examples of the unsaturated polybasic acid include unsaturated dibasic acids such as maleic anhydride, maleic acid, fumaric acid, and itaconic acid. Examples of the saturated polybasic acid include saturated dibasic acids such as phthalic acid, phthalic anhydride, isophthalic acid, terephthalic acid, succinic acid, adipic acid, and sebatic acid; and acids other than dibasic acids, such as benzoic acid and trimellitic acid.

Examples of the polyhydric alcohol include glycols such as ethylene glycol, propylene glycol, diethylene glycol, dipropylene glycol, neopentyl glycol, hydrogenated bisphenol A, and 1,6-hexanediol.

It is possible to commonly use, as the crosslinking agent, an unsaturated monomer which is crosslinkable with a thermosetting resin as mentioned below. The thermosetting resin is a polycondensed product of an unsaturated polybasic acid with a polyhydric alcohol. There is no particular limitation on the unsaturated monomer. And it is possible to use, for example, a styrene-based monomer, vinyltoluene, vinyl acetate, diallyl phthalate, triallyl cyanurate, an acrylic acid ester, and a methacrylic acid ester such as methyl methacrylate or ethyl methacrylate.

Typical examples of the unsaturated polyester resin include a maleic anhydride-propylene glycol-styrene-based resin, and the like.

A thermosetting resin can be obtained by reacting the above-mentioned unsaturated polybasic acid with a polyhydric alcohol through a polycondensation reaction, followed by radical polymerization of a crosslinking agent.

A known method can be used as a method for curing the unsaturated polyester resin and, for example, a curing agent such as a radical polymerization initiator may be added, and optional heating or irradiation with active energy rays. Known curing agents can be used. Examples thereof include peroxydicarbonates such as t-amylperoxy isopropyl carbonate; ketone peroxides, hydroperoxides, diacyl peroxides, peroxy ketals, dialkyl peroxides, peroxy esters, alkyl peresters, and the like. These curing agents may be used alone, or two or more kinds of them may be used in combination.

It is also possible to use, as the thermosetting resin used in the present invention, resins obtained by curing an epoxy-based acrylate resin, as mentioned above.

The epoxy-based acrylate resin is a resin having a functional group, which is polymerizable by a polymerization reaction, in an epoxy resin skeleton. The epoxy-based acrylate resin is a reaction product obtained by the following. That is, a monoester of an unsaturated monobasic acid such as acrylic acid or methacrylic acid, or an unsaturated dibasic acid such as maleic acid or fumaric acid, is ring-opened. And the ring-opened one is added to one epoxy group of an epoxy resin having two or more epoxy groups in a molecule. Usually, this reaction product is in a state of a liquid resin by a diluent. Examples of the diluent include radical-polymerization reactive monomers such as styrene, methyl methacrylate, ethylene glycol dimethacrylate, vinyl acetate, diallyl phthalate, triallyl cyanurate, acrylic acid ester, and methacrylic acid ester.

Herein, known epoxy resins can be used as the epoxy resin skeleton. Specific examples thereof include a bisphenol type epoxy resin such as a bisphenol A type epoxy resin, a bisphenol F type epoxy resin, or a bisphenol S type epoxy resin, which is synthesized from bisphenol A, bisphenol F or bisphenol S and epichlorohydrin; a phenol novolak type epoxy resin which is synthesized from a so-called phenol novolak resin obtained by reacting phenol with formaldehyde in the presence of an acidic catalyst, and epichlorohydrin; and a novolak epoxy resin such as a cresol novolak type epoxy resin which is synthesized from a so-called cresol novolak resin obtained by reacting cresol with formaldehyde in the presence of an acidic catalyst, and epichlorohydrin.

Curing can be performed in the same manner as in the unsaturated polyester resin. And a cured article of an epoxy-based acrylate resin can be obtained by using the same curing agent as mentioned above.

In this case, the thermosetting resin to be used may be obtained by curing an unsaturated polyester resin or an epoxy-based acrylate resin. Alternatively it may be obtained by curing the mixture of both resins. Resins other than these resins may also be contained.

When using an epoxy resin, it is possible to use a bisphenol A type epoxy resin, a bisphenol F type epoxy resin, a bisphenol S type epoxy resin, a biphenyl type epoxy resin, a naphthalenediol type epoxy resin, a phenol novolak type epoxy resin, a cresol novolak type epoxy resin, a bisphenol A novolak type epoxy resin, a cyclic aliphatic epoxy resin, a heterocyclic epoxy resin (triglycidyl isocyanurate, diglycidyl hydantoin, etc.) and modified epoxy resins obtained by modifying these resins with various materials.

It is also possible to use halides such as bromide and chloride of these resins. It is also possible to appropriately use two or more kinds of these resins in combination.

It is preferred to use a phenol novolak type epoxy resin, a cresol novolak type epoxy resin or a bisphenol A novolak type epoxy resin, or halides thereof. This is because it is possible to impart high heat resistance and reliability to an insulating layer. The high heat resistance and reliability can be used for applications of electrical and electronic materials.

Known curing agents such as phenol-based, amine-based, and cyanate-based compounds can be used alone or in combination, as the curing agent.

Specific examples thereof include phenol-based curing agents having a phenolic hydroxyl group, such as phenol novolak, cresol novolak, bisphenol A, bisphenol F, bisphenol S, and melamine-modified novolak type phenol resins; or halogenated curing agents thereof; and amine-based curing agents such as dicyandiamide.

It is possible to use, as the thermoplastic resin, a polyolefin-based resin, a polyamide-based resin, an elastomer-based (styrene-based, olefin-based, polyvinyl chloride (PVC)-based, urethane-based, ester-based, or amide-based) resin, an acrylic resin, a polyester-based resin, an engineering plastic, and the like. In particular, resins to be selected are polyethylene, polypropylene, a nylon resin, an acrylonitrile-butadiene-styrene (ABS) resin, an acrylic resin, an ethylene acrylate resin, an ethylene-vinyl acetate resin, a polystyrene resin, a polyphenylene sulfide resin, a polycarbonate resin, a polyester elastomer resin, a polyamide elastomer resin, a liquid crystal polymer, a polybutylene terephthalate resin, and the like. Of these resin, a nylon resin, a polyester elastomer resin, a polyamide elastomer resin, an ABS resin, a polypropylene resin, a polyphenylene sulfide resin, a liquid crystal polymer, and a polybutylene terephthalate resin are preferably used in view of heat resistance and flexibility.

As long as the effects of the embodiment of the present invention are not impaired, the thermally conductive resin composition 1 according to the embodiment of the present invention may contain the followings: a fiber reinforcer, a shrinkage diminishing agent, a thickener, a colorant, a flame retardant, an auxiliary flame retardant, a polymerization inhibitor, a polymerization delaying agent, a curing accelerator, a viscosity reducing agent for the adjustment of a viscosity during production, a dispersion control agent for the improvement of dispersibility of a toner (colorant), a mold releasant, and the like. It is possible to use known additives. Examples thereof include the followings.

Inorganic fibers such as glass fibers and various organic fibers can be used as the fiber reinforcer. Sufficient reinforcing effect or moldability can be obtained when the fiber length is, for example, from about 0.2 to 30 mm.

It is possible to use, as the shrinkage diminishing agent, polystyrene, polymethyl methacrylate, cellulose acetate butyrate, polycaprolactane, polyvinyl acetate, polyethylene, polyvinyl chloride, and the like. These shrinkage diminishing agents may be used alone, or two or more kinds of them may be used in combination.

It is possible to use, as the thickener, light-burned MgO (produced by a light burning method), Mg(OH)₂, Ca(OH)₂, CaO, tolylene diisocyanate, diphenylmethane diisocyanate, and the like. These thickeners may be used alone, or two or more kinds of them may be used in combination.

It is possible to use, as the colorant, inorganic pigments such as titanium oxide; organic pigments; or toners containing them as main components. These colorants may be used alone, or two or more kinds of them may be used in combination.

Examples of the flame retardant include an organic flame retardant, an inorganic flame retardant, a reactive system flame retardant, and the like. Two or more kinds of these flame retardants can be used in combination. In case that the thermally conductive resin composition 1 according to the embodiment of the present invention is allowed to contain a flame retardant, an auxiliary flame retardant is preferably used in combination.

Examples of the auxiliary flame retardant include antimony compounds such as diantimony trioxide, diantimony tetraoxide, diantimony pentoxide, sodium antimonate, and antimony tartrate; zinc borate, barium metaborate, hydrated alumina, zirconium hydroxide, ammonium phosphate, tin oxide, iron oxide, and the like. These auxiliary flame retardants may be used alone, or two or more kinds of them may be used in combination.

It is possible to use, as the mold releasant, for example, stearic acid, and the like.

### [Method for Producing Thermally Conductive Resin Composition]

The method for producing a thermally conductive resin composition according to the embodiment of the present invention will be described in detail below. A production method using a thermosetting resin 1 be described in detail below as an example.

The respective raw materials, fillers, and thermosetting resins used to produce a thermally conductive resin composition are blended in predetermined proportions. And they are mixed by a mixer, a blender, or the like. And then the mixture is kneaded by a kneader, a roll, or the like, to obtain a thermosetting resin composition (hereinafter referred to as a compound) in an uncured state. After preparing separable upper and lower molds capable of imparting the objective molding shape, the compound was injected into the molds in the used amount, followed by heating under pressure. After opening the molds, the objective molded product can be removed. It is possible to appropriately select the molding temperature, molding pressure, and the like depending on the shape of the objective molded article.

It is also possible to produce a complex of a thermally conductive resin composition and metal by the following process. That is, a metal foil such as a copper foil, or a metal plate is placed on molds in the case of charging the compound. And then the compound is laminated, and subsequently it is heated under pressure.

The molding conditions vary depending on kinds of the thermosetting resin composition and are not particularly limited. For example, molding can be performed under a molding pressure of 3 to 30 MPa at a molding temperature of 120 to 150° C. for 3 to 10 minutes (molding time). Various known molding methods can be used as the molding method. For example, compression molding (direct pressure molding), transfer molding, injection molding, and the like can be preferably used.

The thermally conductive resin composition obtained in the way mentioned above exhibits larger contact area between fillers than that of a thermally conductive resin composition using conventional fillers. Thus, it is made possible to efficiently realize high thermal conduction. Since the content of the filler can be decreased, fluidity of the thermally conductive resin composition is improved. As a result, satisfactory moldability of the thermally conductive resin composition can be obtained.

### [Thermal Conductivity]

The irregularly shaped filler 4 and small diameter filler 5 preferably have thermal conductivity of 10 W/m·K or more. In case that the irregularly shaped filler 4 and small diameter filler 5 have thermal conductivity of 10 W/m·K or more, it is possible to further enhance the thermal conductivity of the cured thermally conductive resin composition (molding 12). There is no particular limitation on the upper limit of thermal conductivity of the irregularly shaped filler 4 and small diameter filler 5.

### EXAMPLES

The present invention will be described in more detail below by way of Examples, but the present invention is not limited to these Examples.

The followings were used as inorganic fillers. MgO produced by a dead burning method was used. A and B are those in which a plurality of the particles according to the embodiment of the present invention are partially consolidated each other. C, D, and E are crushed products. Al(OH)₃ is a crushed product. BN is a hexagonal crystal and has a scaly shape.

Details thereof are shown below.

MgO-A: having a median diameter of 20 μm, and a specific surface area of 1.40 m²/g
MgO-B: having a median diameter of 90 μm, and a specific surface area of 0.32 m²/g
MgO-C: having a median diameter of 5 μm, and a specific surface area of 0.55 m²/g
MgO-D: having a median diameter of 20 μm, and a specific surface area of 0.09 m²/g
MgO-E: having a median diameter of 90 μm, and a specific surface area of 0.02 m²/g
Al(OH)₃: having a median diameter of 8 μm, and a specific surface area of 0.72 m²/g
BN: having a median diameter of 9 μm, and a specific surface area of 4.00 m²/g

### Example 1

One hundred (100) parts by mass of an unsaturated polyester resin (M-640LS, manufactured by Showa High Polymer Co., Ltd.), 1 part by mass of t-amylperoxy isopropyl carbonate as a curing agent, 0.1 part by mass of p-benzoquinone as a polymerization inhibitor, 5 parts by mass of stearic acid as a mold releasant, 200 parts by mass of MgO-A as a filler, and 1 part by mass of a light-burned magnesium oxide (produced by a light burning method) as a thickener were well mixed to obtain a compound. Subsequently, this compound was aged at 40° C. for 24 hours, and then thickened until stickiness disappears.

The compound produced in the way mentioned above was disposed in upper and lower molds set at a molding temperature of 145° C. And then it was pressed under a molding pressure of 7 MPa at a molding temperature of 145° C. The molding time was set at 4 minutes. Whereby, an unsaturated polyester resin in a compound was melt-softened by heating, leading to deformation into a predetermined shape, followed by curing to obtain a resin composition.

### Example 2

### Comparative Examples 1 to 2

In the same manner as in Example 1, except that kinds and parts of fillers were respectively changed as shown in Table 1, resin compositions were obtained.

### Example 3

One hundred (100) parts by mass of an epoxy-based acrylate resin (NEOPOL 8250H, manufactured by U-PICA Company. Ltd.), 1 part by mass of t-amyl peroxyisopropyl carbonate as a curing agent, 0.1 part by mass of p-benzoquinone as a polymerization inhibitor, 5 parts by mass of stearic acid as a mold releasant, 600 parts by mass of MgO-B and 400 parts by mass of MgO-C as fillers were well mixed to obtain a compound.

The compound produced in the way mentioned above was disposed in upper and lower molds set at a molding temperature of 145° C. And then it was pressed under a molding pressure of 7 MPa at a molding temperature of 145° C. The molding time was set at 4 minutes. Whereby, an epoxy-based acrylate resin in a compound was melt-softened by heating, leading to deformation into a predetermined shape, followed by curing to obtain a resin composition.

### Examples 4 to 5

### Comparative Examples 3 to 6

In the same manner as in Example 3, except that kinds and parts of fillers were respectively changed as shown in Table 1, the thermally conductive resin compositions were obtained.

### Example 6

Mg(OC₂H₅)₂ (1 molar ratio) as a metal alkoxide was well mixed with a solution of ethanol (50 molar ratio), acetic acid (10 molar ratio), and water (50 molar ratio) while stirring at room temperature to prepare a sol-gel liquid. And then MgO-C was dispersed therein to obtain a slurry. MgO-F (having a median diameter of 40 μm and a specific surface area of 0.06 m²/g, crushed product) was charged in a pan type granulator. And then the slurry thus prepared was sprayed by a spray gun. The obtained powder was charged in a tray and then dried overnight at 150° C. Subsequently, the dried powder was burned in atmospheric air at 500° C. for 5 hours. And then it was subjected to a crushing treatment using a pot mill. Using a mesh sieve, fillers of 100 μm or more in size were removed to produce an irregularly shaped filler MgO-C/F. This irregularly shaped filler had a median diameter of 60 μm and a specific surface area of 0.08 m²/g.

Next, 100 parts by mass of an epoxy-based acrylate resin (NEOPOL 8250H, manufactured by U-PICA Company. Ltd.), 1 part by mass of t-amylperoxy isopropyl carbonate as a curing agent, 0.1 part by mass of p-benzoquinone as a polymerization inhibitor, 5 parts by mass of stearic acid as a releasant, 600 parts by mass of MgO-C/F and 400 parts by mass of MgO-C as fillers were well mixed to obtain a compound.

### [Volume Ratio of Filler]

A volume ratio was calculated by the following method. First, the volume of a thermally conductive resin composition was calculated by the Archimedean method. And then the thermally conductive resin composition was burned at 625° C. using a muffle furnace, followed by the measurement of the weight of ash. Since ash is a filler, each volume % was calculated from a blending ratio to obtain a volume ratio. In that case, each density was assumed as follows: MgO; 3.65 g/cm³, Al(OH)₃; 2.42 g/cm³, and BN; 2.27 g/cm³. With respect to Al(OH)₃, calculation was performed taking dewatering into consideration.

### [Thermal Conductivity of Thermally Conductive Resin Composition]

Samples each measuring 10 mm square and 2 mm in thickness were cut from the cured thermally conductive resin composition (molding). Using a Xenon flash (thermal conductivity) analyzer LFA 447 manufactured by NETZSCH, the measurement was performed at 25° C.

### [Moldability]

From a molding state of a plate-like test piece of a mold opening measuring 300 mm and 2.5 mm in thickness, moldability was visually judged according to the following criteria.

G (good): Molding could be performed without observing molding defects.
B (bad): Molding could not be performed due to short shot.

TABLE 1

| Blending conditions/Evaluation items | | | Example 1 | Example 2 | Example 3 | Example 4 | Example 5 | Example 6 |
|---|---|---|---|---|---|---|---|---|
| Blending | Thermosetting | Unsaturated polyester resin | 100 | 100 | 0 | 0 | 0 | 0 |
| amount | resin | Epoxy-based acrylate resin | 0 | 0 | 100 | 100 | 100 | 100 |
| (parts by | Curing agent | t-Amylperoxy isopropyl | 1 | 1 | 1 | 1 | 1 | 1 |
| mass) | | carbonate | | | | | | |
| | Polymerization | p-Benzoquinone | 0.1 | 0.1 | 0.1 | 0.1 | 0.1 | 0.1 |
| | inhibitor | | | | | | | |
| | Mold release | Stearic acid | 5 | 5 | 5 | 5 | 5 | 5 |
| | agent | | | | | | | |
| | Inorganic filler | MgO-A (20 μm, 1.40 m²/g) | 200 | 0 | 0 | 0 | 0 | 0 |
| | | MgO-B (90 μm, 0.32 m²/g) | 0 | 300 | 600 | 550 | 410 | 0 |
| | | MgO-C (5 μm, 0.55 m²/g) | 0 | 0 | 400 | 0 | 270 | 400 |
| | | MgO-D (20 μm, 0.09 m²/g) | 0 | 0 | 0 | 0 | 0 | 0 |
| | | MgO-E (90 μm, 0.02 m²/g) | 0 | 0 | 0 | 0 | 0 | 0 |
| | | Al(OH)₃ (20 μm, 0.72 m²/g) | 0 | 0 | 0 | 160 | 0 | 0 |
| | | BN (9 μm, 4.00 m²/g) | 0 | 0 | 0 | 0 | 70 | 0 |
| | | MgO-C/F (60 μm, 0.08 m²/g) | 0 | 0 | 0 | 0 | 0 | 600 |
| | Thickener | Light-burned magnesium | 1 | 1 | 0 | 0 | 0 | 0 |
| | | oxide (produced by light | | | | | | |
| | | burning method) | | | | | | |

| | | | | | | |
|---|---|---|---|---|---|---|
| Volume ratio of inorganic filler (volume %) | 38 | 50 | 71 | 71 | 71 | 71 |
| Irregular-shaped filler:Small diameter filler (volume ratio) | 10:1 | 10:0 | 6:4 | 6.9:3.1 | 5.2:4.8 | 6:4 |
| Thermal conductivity of insulating resin composition 1.8 | 3.2 | 6.8 | 4.3 | 6.6 | 6.2 | |
| (W/mK) | | | | | | |
| Moldability | G | G | G | G | G | G |

| | | | | | | Compar- | Compar- | Compar- |
|---|---|---|---|---|---|---|---|---|
| | | | Comparative | Comparative | Comparative | ative | ative | ative |
| Blending conditions/Evaluation items | | | Example 1 | Example 2 | Example 3 | Example 4 | Example 5 | Example 6 |
| Blending | Thermosetting | Unsaturated polyester resin | 100 | 100 | 0 | 0 | 0 | 0 |
| amount | resin | Epoxy-based acrylate resin | 0 | 0 | 100 | 100 | 100 | 100 |
| (parts by | Curing agent | t-Amylperoxy isopropyl | 1 | 1 | 1 | 1 | 1 | 1 |
| mass) | | carbonate | | | | | | |
| | Polymerization | p-Benzoquinone | 0.1 | 0.1 | 0.1 | 0.1 | 0.1 | 0.1 |
| | inhibitor | | | | | | | |
| | Mold release | Stearic acid | 5 | 5 | 5 | 5 | 5 | 5 |
| | agent | | | | | | | |
| | Inorganic filler | MgO-A (20 μm, 1.40 m²/g) | 0 | 0 | 0 | 0 | 0 | 0 |
| | | MgO-B (90 μm, 0.32 m²/g) | 0 | 0 | 0 | 0 | 0 | 0 |
| | | MgO-C (5 μm, 0.55 m²/g) | 0 | 0 | 400 | 0 | 270 | 560 |
| | | MgO-D (20 μm, 0.09 m²/g) | 200 | 0 | 0 | 0 | 0 | 0 |
| | | MgO-E (90 μm, 0.02 m²/g) | 0 | 300 | 600 | 550 | 410 | 840 |
| | | Al(OH)₃ (20 μm, 0.72 m²/g) | 0 | 0 | 0 | 160 | 0 | 0 |
| | | BN (9 μm, 4.00 m²/g) | 0 | 0 | 0 | 0 | 70 | 0 |
| | | MgO-C/F (60 μm, 0.08 m²/g) | 0 | 0 | 0 | 0 | 0 | 0 |
| | Thickener | Light-burned magnesium | 1 | 1 | 0 | 0 | 0 | 0 |
| | | oxide (produced by light | | | | | | |
| | | burning method) | | | | | | |

| | | | | | | |
|---|---|---|---|---|---|---|
| Volume ratio of inorganic filler (volume %) | 38 | 50 | 71 | 71 | 71 | 82 |
| Irregular-shaped filler:Small diameter filler | — | — | — | — | — | — |
| (volume ratio) | | | | | | |
| Thermal conductivity of insulating resin composition | 1.1 | 1.8 | 4.2 | 3.0 | 4.8 | — |
| (W/mK) | | | | | | |
| Moldability | G | G | G | G | G | B |

The followings became apparent from Table 1.

In Examples 1 to 5, high thermal conductivity was exhibited in spite of containing a filler in the same volume % as that in Comparative Examples 1 to 5. Specifically, in Example 1 and Comparative Example 1, in spite of the fact that the volume ratio of an inorganic filler is the same, i.e. 38% by volume in both cases, the thermal conductivity is 1.1 W/mK in Comparative Example 1. The thermal conductivity is 1.8 W/mK in Example 1. In Example 1 according to the present invention, high thermal conductivity was exhibited as compared with Comparative Example 1. In Example 2 and Comparative Example 2, in spite of the fact that the volume ratio of an inorganic filler is the same, i.e. 50% by volume in both cases, the thermal conductivity is 1.8 W/mK in Comparative Example 2. The thermal conductivity is 3.2 W/mK in Example 2. In Example 2 according to the present invention, high thermal conductivity was exhibited as compared with Comparative Example 2. In Example 3 and Comparative Example 3, in spite of the fact that the volume ratio of an inorganic filler is the same, i.e. 71% by volume in both cases, the thermal conductivity is 4.2 W/mK in Comparative Example 3. The thermal conductivity is 6.8 W/mK in Example 3. In Example 3 according to the present invention, high thermal conductivity was exhibited as compared with Comparative Example 3. In Example 4 and Comparative Example 4, in spite of the fact that the volume ratio of an inorganic filler is the same, i.e. 71% by volume in both cases, the thermal conductivity is 3.0 W/mK in Comparative Example 4. The thermal conductivity is 4.3 W/mK in Example 4. In Example 4 according to the present invention, high thermal conductivity was exhibited as compared with Comparative Example 4. In Example 5 and Comparative Example 5, in spite of the fact that the volume ratio of an inorganic filler is the same, i.e. 71% by volume in both cases, the thermal conductivity is 4.8 W/mK in Comparative Example 5. The thermal conductivity is 6.6 W/mK in Example 5. In Example 5 according to the present invention, high thermal conductivity was exhibited as compared with Comparative Example 5. As mentioned above, in Examples 1 to 5, high thermal conductivity was exhibited in spite of containing a filler in the same volume % as that in Comparative Examples 1 to 5.

Example 6 is directed to a thermally conductive resin composition in which the inorganic filler MgO-B in Example 3 was changed to MgO-C/F. The thermal conductivity was 6.8 W/mK in Example 3. The thermal conductivity was 6.2 W/mK in Example 6. In Example 6, the same thermal conductivity as in Example 3 could be obtained.

In Comparative Example 6, the amount of a filler was increased so as to achieve the thermal conductivity equivalent to that in Example 3. Because of large content of the filler, fluidity during molding decreased, thus failed to perform molding.

As is apparent from the above description, according to the embodiment of the present invention, it is possible to obtain a thermally conductive resin composition which exhibits satisfactory moldability while maintaining high thermal conductivity.

### EXPLANATION OF REFERENCES

1, 20 thermally conductive resin composition
2, 25 thermally conductive fillers
3 binder resin
4 irregularly shaped filler
5 small diameter filler
6 welded portions
7 thermally conductive filler particle
8 gap
9 contact points
10 recesses
11 projections
12 molding
21 large diameter filler
22 small diameter filler
23 binder resin
24 contact points

1. A thermally conductive resin composition, comprising:
a thermally conductive filler; and
a binder resin,
wherein the thermally conductive resin composition contains, as the thermally conductive filler, an irregularly shaped filler having projection/recess structures on its surface.

2. The thermally conductive resin composition according to claim 1, wherein the irregularly shaped filler comprises a secondary particle assembled by bonding a plurality of the thermally conductive primary particles together.

3. The thermally conductive resin composition according to claim 1,
wherein one particle composing the irregularly shaped filler comprises a first particle and a second particle having a particle size being smaller than that of the first particle, and
wherein a plurality of the second particles are bonded to a surface of a core portion of the first particle to form the projection/recess structures on a surface of the core portion.

4. The thermally conductive resin composition according to any one of claims 1 to 3, wherein the irregularly shaped filler has a median diameter of 10 to 100 μm.

5. The thermally conductive resin composition according to any one of claims 1 to 4, further comprising, as the thermally conductive filler, a small diameter filler having a median diameter being smaller than that of the irregularly shaped filler.

6. The thermally conductive resin composition according to claim 5, wherein the small diameter filler has a median diameter of 1 to 10 μm.

7. The thermally conductive resin composition according to claim 5 or 6, wherein a volume ratio of the irregularly shaped filler to the small diameter filler is from 4:6 to 7:3.

8. The thermally conductive resin composition according to any one of claims 1 to 7, which contains 35 to 80% by volume of the thermally conductive filler.

9. A thermally conductive molding obtained by molding the thermally conductive resin composition according to any one of claims 1 to 8, projections of other particles of the irregularly shaped filler entered into the recesses of particles of the irregularly shaped filler.

10. A thermally conductive molding obtained by molding the thermally conductive resin composition according to any one of claims 5 to 7, wherein the small diameter filler enters into the recesses of particles of the irregularly shaped filler.
